(19) United States
(12) Patent Application Publication
(10) Pub. No.: US 2005/0213455 A1
(43) Pub. Date: Sep. 29, 2005

(54) Recording/reproducing device and recording method

(75) Inventor: Hiroyuki Takayama, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/084,031

(22) Filed: Mar. 21, 2005

(30) Foreign Application Priority Data
Mar. 24, 2004 (JP) 2004-087673

(51) Int. Cl. G11B 7/00

(52) U.S. Cl. 369/53.21; 369/47.22

(57) ABSTRACT

The present invention aims at providing a recording method for making a request for selecting whether or not to perform finalizing processing on a disc inserted in a DVD-R or a DVD-RW recording device, capable of reducing unnecessary operations and effectively using the recording capacity of the DVD-R or the DVD-RW. The DVD-R or the DVD-RW recording device includes user information input/output means including recording means for recording data in the disc and display means and central processing means for processing information input by the user or recorded information in the inserted disc, inputs and sets a reference based on which a finalizing processing selection is displayed, detects the presence/absence of a finalizing record of the inserted disc and an amount of remaining capacity therein, decides and displays whether the detected amounts meet the reference or not, performs finalizing processing as required and performs processing of unloading the disc. The display contents include an amount of remaining capacity of the disc and amount of remaining capacity according to the recording mode.

The present application is based on and claims priority of Japanese patent applications No. 2004-087673 filed on Mar. 24, 2004, the entire contents of which are hereby incorporated by reference.

### BACKGROUND OF THE INVENTION

1. Field of the Invention

The present invention relates to a recording/reproducing device for a recording medium such as DVD which allows a user to select whether or not to apply finalizing processing to the recording medium such as a DVD when it is unloaded from the recording/reproducing device.

2. Description of the Related Art

With the widespread proliferation of DVD in recent years, write-once optical disc and readable/writable optical disc compatible with DVD, that is, DVD-R and DVD-RW are becoming widespread. Since these media have an extremely large recording capacity, they wield their power when saving image data of moving images such as movie, however, before data in these media is subjected to saving processing, the data must be subjected to finalizing recording in a logical format for a DVD and the like.

The logical format for a DVD is specified in the micro UDF and ISO9660, but any DVD-R, DVD-RW without being subjected to finalizing recording cannot be reproduced by a DVD reproducing device.

On the other hand, it is possible to additionally record data in a same DVD recording device as long as there is a free space, but repeating loading and unloading of a disc into/from the DVD recording device after this additional recording is likely to contaminate the disc in an environment outside the recording device, which may compromise the finalized record for a recording medium which is being processed finer as its recording capacity increases. Therefore, there are proposals such that a disc is prevented from unloading operation before finalizing recording which is in the process of recording or having a free recording space, or such that prompts a user to select whether or not to perform finalizing processing and perform unloading processing after processing according to the selection.

[Patent Document 1] Japanese Patent Laid-Open Publication No. 2002-373418

[Patent Document 2] Japanese Patent Laid-Open Publication No. 2002-373423

However, since this prompt for a selection of finalizing processing equally requires a decision on whether or not to perform the processing, the user needs to make a decision considering the appropriateness by himself/herself. However, it is often the case that the user does not always comprehend the recording situation of the disc set in a recording device. For example, the user needs to decide whether or not to perform finalizing recording by deciding whether the disc is a completely unrecorded new disc or whether the disc is in the process of recording, or by judging the amount or percentage of free recording space and the situation in which the user needs to know the free space when additional recording is performed, and the like.

Under such circumstances, prior arts always request the user to select whether or not to perform finalizing processing irrespective of whether or not such processing is necessary for the inserted disc, which is complicated or may sometimes provoke unnecessary operations. Furthermore, there are many cases where a DVD-R, a DVD-RW, and the like having a large recording capacity still has a sufficient free space but the disc is subjected to finalizing processing without fully using this free space.

### SUMMARY OF THE INVENTION

The present invention aims at providing a recording/reproducing device using a recording medium such as a DVD-R and a DVD-RW capable of displaying a request as to whether or not to perform finalizing processing on a disc inserted, reduce unnecessary operations, simultaneously clarify the appropriateness of performing finalizing processing so as to effectively use the recording capacity of the DVD-R or the DVD-RW.

The recording/reproducing device according to the present invention comprises user information input/output means including recording means for recording data in a disc and display means and central processing means for processing information input by a user or the recorded information in the inserted disc, wherein the central processing means inputs and sets a reference for the user input means to perform finalizing processing, detects the presence/absence of a finalizing record of the inserted disc and an amount of remaining capacity therein to decide whether the detected amounts meet the reference or not, displays a selection as to whether or not to perform finalizing processing, performs finalizing processing in response to a selected finalizing processing request, and performs processing of unloading the disc.

Furthermore, the recording/reproducing device according to the present invention include an amount of remaining capacity of the disc and an amount of remaining capacity therein according to a recording mode as the above described reference for input settings and these amounts are displayed on a finalizing processing selection screen.

The recording/reproducing method according to the present invention comprises the steps of inputting/setting a reference for the user input means to perform finalizing processing, detecting the presence/absence of a finalizing record in an inserted disc and an amount of remaining capacity therein to decide whether the detected amounts meet the reference or not, displaying a selection as to whether or not to perform finalizing processing, performing finalizing processing in response to a request for selected finalizing processing, and performing processing of unloading the disc.

Thus, the recording/reproducing device for a recording medium such as a DVD-R or a DVD-RW according to the present invention is provided with the central processing means for processing information input by the user or from the information recorded in the inserted disc, and the central processing means inputs and sets the user reference for selecting/displaying finalizing processing by the user input means, detects the presence/absence of the finalizing record of the inserted disc and the amount of remaining capacity therein to decide whether the detected amounts meet the reference or not, displays a selection as to whether or not to perform finalizing processing, performs finalizing processing according to an instruction from the selected finalizing processing, and performs processing of unloading the disc. Furthermore, an amount of remaining capacity of the disc and an amount of remaining capacity therein according to a recording mode are included as the above described reference and these amounts can be displayed on a finalizing processing selection screen.

The recording/reproducing device and recording method for a recording medium such as DVD-R or a DVD-RW according to the present invention detects a disc recording situation, displays a finalizing processing selection request screen when the disc recording situation meets a preset reference, allows the user to unload the disc by deciding use or disuse of the finalizing processing according to the display content, and can thereby reduce unnecessary operations and botheration and avoid wasting an enormous recording capacity of the disc.

### BRIEF DESCRIPTION OF THE DRAWINGS

FIG. 1 is a reference drawing showing an example of a finalizing setting screen;

FIG. 2 is a reference drawing showing a finalizing processing determination screen;

FIG. 3 is a reference drawing showing a finalizing setting screen using an amount used of a disc recording medium as a reference;

FIG. 4 is a flow chart showing processing steps for unloading a disc recording medium;

FIG. 5 is a flowchart showing finalizing processing steps for a recorded disc;

FIG. 6 is a block diagram of the entire apparatus of the present invention; and

FIG. 7 is an internal block diagram of a microcomputer.

### DETAILED DESCRIPTION OF THE PREFERRED EMBODIMENTS

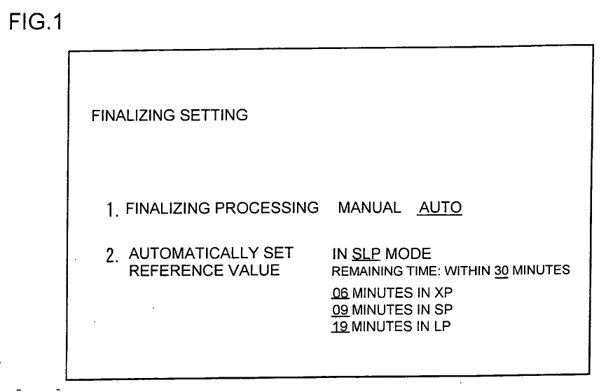

FIG. 1 shows an example of a finalizing setting screen and allows the user to select not only a so-called “manual” mode in which finalizing recording is performed as a normal processing operation but also an “auto” mode in which the user decides whether or not to perform finalizing processing according to a preset reference and conditions under which the user decides on the selection prompt are displayed.

When the “manual” mode is set, the user decides whether the user himself/herself performs finalizing processing or not and gives an instruction for unloading the disc. On the other hand, when the “auto” mode is set, it is possible to preset auto setting reference values as to under any conditions a screen for prompting a selection of automatic finalizing processing should be displayed according to the user s need.

In the example shown in the figure, a reference value is decided based on a recording mode and remaining time which indicates an amount of free space and a confirmation screen as to whether finalizing processing should be performed or not is automatically shown if a disc unloading operation is performed in the case where the remaining time is not more than 30 minutes in an SLP mode.

On this screen, it is also possible to set other values as initial values and the example in the figure shows modes and remaining times for recording in their respective modes as values related thereto at the bottom of the screen so that they can be referenced. Examples include displays like “06 minutes in XP”, “09 minutes in SP”, “19 minutes in LP”, and the like, and the user can select and instruct the time value in minutes.

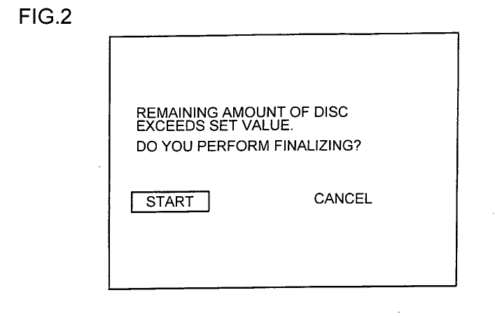

FIG. 2 shows a case of an auto display when a remaining amount of the disc is set as a reference value in the setting example in FIG. 1 as described above and this screen is automatically displayed according to the reference value set to prompt the user to perform finalizing processing when recording in the disc is completed and an instruction for unloading the disc is given.

To perform the finalizing processing from this screen, “Start” can be selected on the screen. As a result, the finalizing processing is performed, and then the disc is unloaded and can be reproduced by a reproducing device. When the finalizing processing is not performed, “Cancel” should be selected.

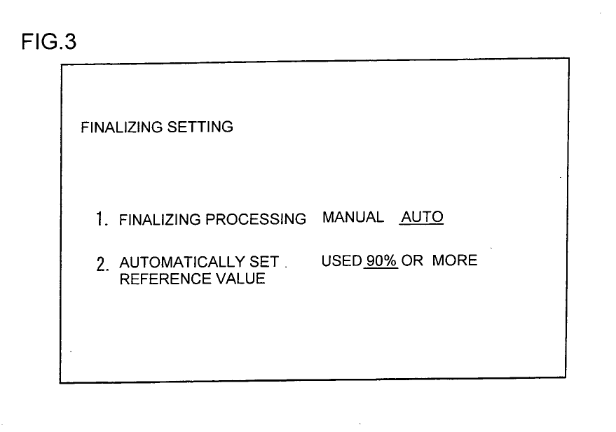

FIG. 3 shows an example where an amount used of the disc recording medium is set as a reference for a finalizing setting condition and show the screen automatically displayed when 90% is recorded. These values can be set arbitrarily by the user and can also be adapted so that in addition to this display, a recording mode and a remaining amount corresponding to the mode can be displayed and referenced.

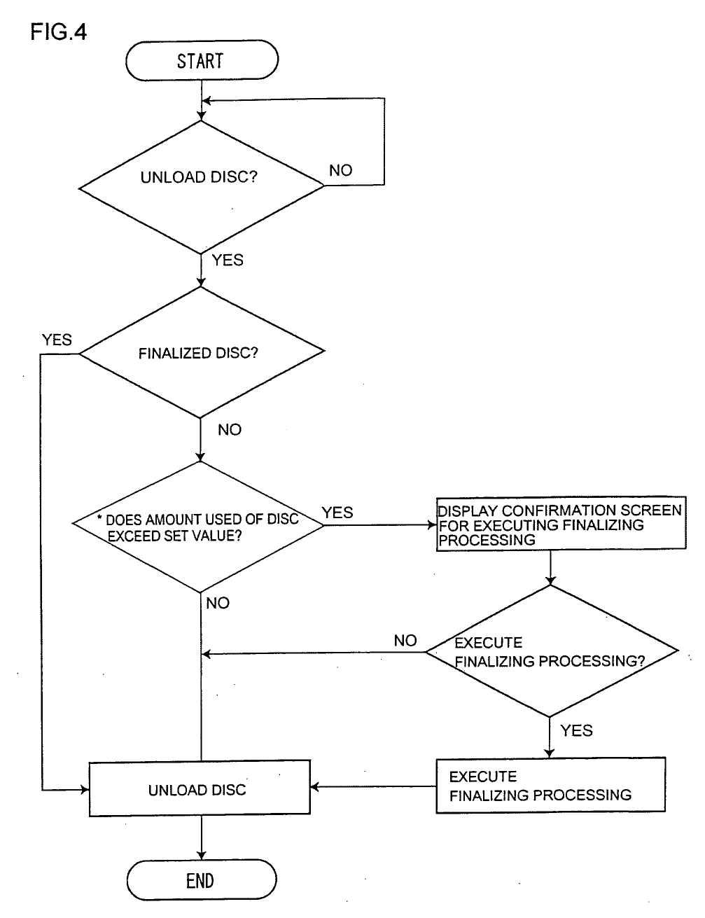

The processing steps for unloading the disc recording medium will be explained with reference to the flow chart in FIG. 4.

This example is a case where a screen for selecting finalizing processing according to an amount used of a disc recording medium in an auto mode is displayed and shows a flow when a new disc is set.

When a disc unloading instruction is received at the start step, an operation control section in a microcomputer decides whether the disc is finalized or not upon reception of a signal from a circuit for detecting the presence/absence of finalizing processing and if the result is YES, a disc unloading instruction is executed.

If the result is NO, the amount used of the disc recording medium is detected and judged whether or not it exceeds a reference value (value set by the user) with reference to the auto display setting condition and if it exceeds the reference value, a confirmation screen for executing finalizing processing is displayed (FIG. 2) and the user is asked to decide whether or not to perform finalizing processing.

When a finalizing processing instruction “Start” is received, finalizing processing is executed and the disc is unloaded. On the other hand, when a decision of not performing finalizing processing “Cancel” is received, the disc is unloaded without performing finalizing processing and in this way the remaining amount of the disc is not wasted.

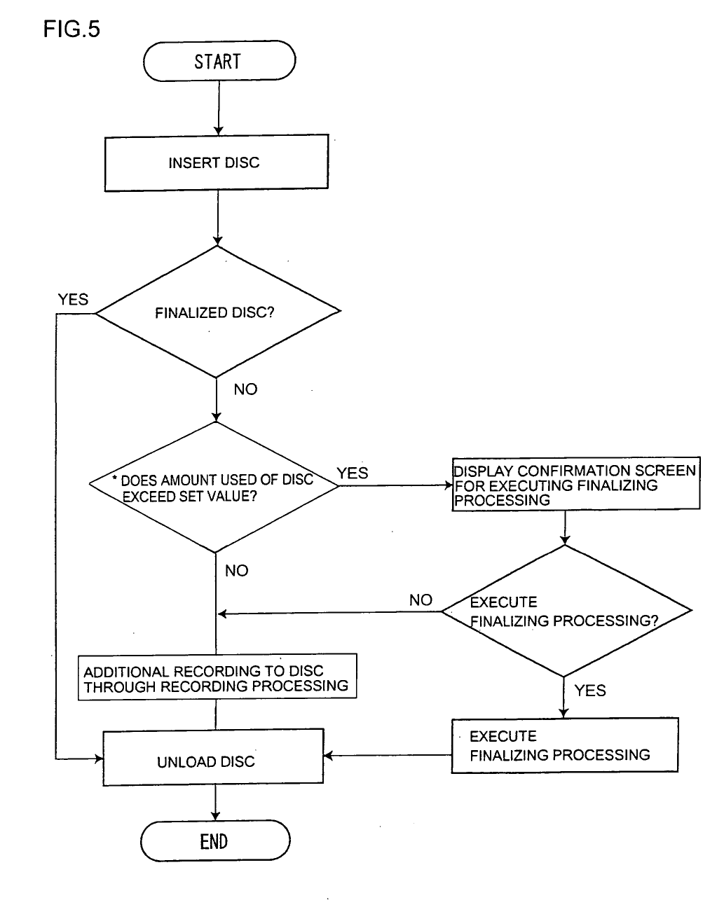

The flow process in FIG. 5 shows steps of an operation example when a disc which has been recorded but not subjected to finalizing processing is inserted in the recording/reproducing device for additional recording. In this case, unlike the case where an unrecorded disc is inserted, whether additional recording is possible or not is displayed by responding to the presence/absence of finalizing processing to allow the user to respond appropriately. The subsequent steps are the same as the case in FIG. 4 as described above except that additional recording processing is performed according to the user's instruction when additional recording is possible.

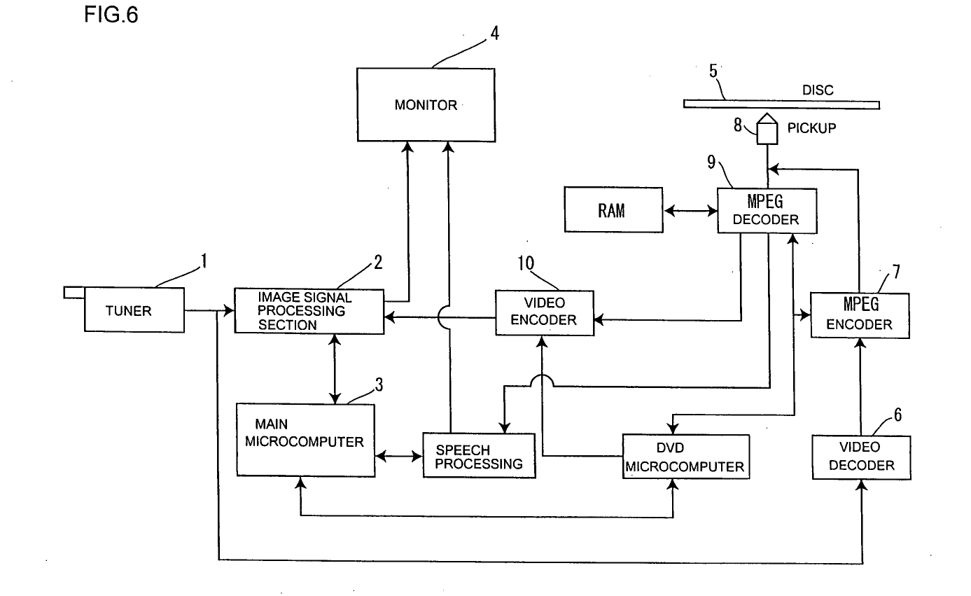

FIG. 6 shows an example of a block diagram of the entire apparatus for the recording/reproducing device making up the system according to the present invention.

Recorded data from a tuner 1 and the like is transmitted via an image signal processing section 2 to a main microcomputer 3 which is a central processing means and a monitor 4 which is a display means, and at the same time, is converted from an analog signal to a digital signal by a video decoder 6 which is a recording means for recording (including additional recording) data on a recording medium (disc) 5 such as DVD-R, DVD-RW, subjected to signal compression processing by an MPEG encoder 7, and recorded from a pickup 8 to a disc 5.

The signal processing and reproduction signal processing through an MPEG decoder 9 to a VIDEO encoder 10 are not different from those in a conventional DVD recording/reproducing device.

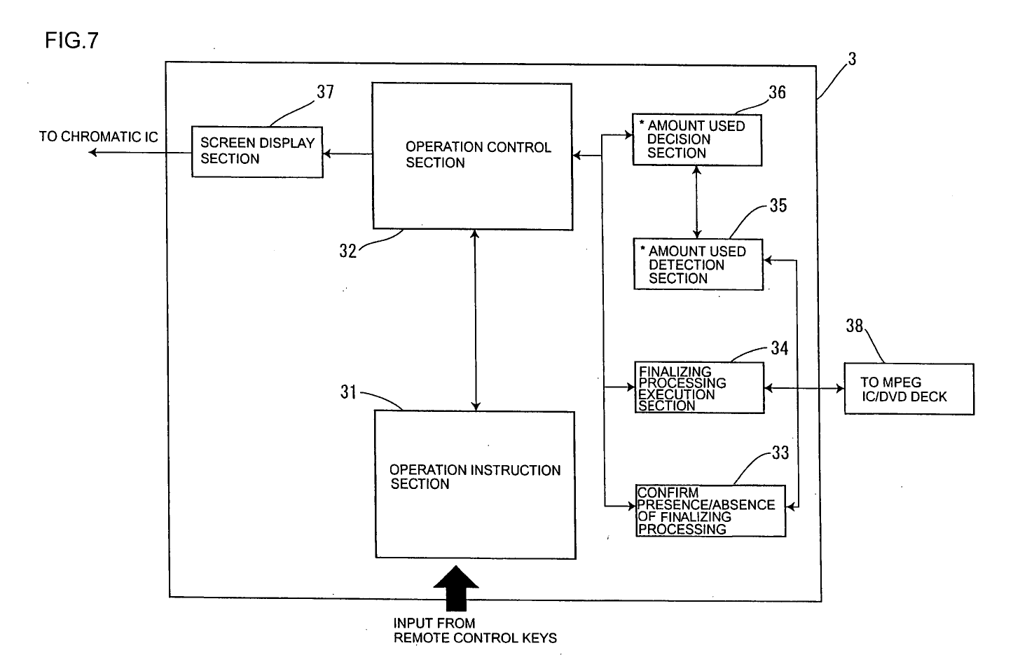

FIG. 7 is an internal block diagram of the main microcomputer 3 which displays finalizing processing according to the present invention.

This example is an operation example preferably applicable when a DVD recording device is operated using remote control keys when recording telecast images and the like. These apparatuses are operated using the remote control keys wherein an input signal is sent from an operation instruction section 31, an operation control section 32 confirms the data of the inserted disc through the steps in the above described flow process from a finalizing processing execution section 34 for an MPEG IC or a DVD DECK 38, thereby confirms the presence/absence of finalizing processing (33), detects an amount used (35), and decides the amount used (36), and depending on the results, the operation control section 32 displays a screen for confirming the presence/absence of finalizing or executing finalizing processing on a screen display section 37.

The DVD data recording method according to the present invention makes it possible to perform reliable and appropriate finalizing processing on a DVD-R, a DVD-RW which is becoming widely available using a procedure which can be easily operated by anyone, resulting to provide effective useful information resources of a DVD having an enormous recording capacity, and further, promote the proliferation thereof and contribute to the development of these new technological fields.

1. A recording/reproducing device for recording medium such as DVD according to the present invention comprising user information input/output means including recording means for recording data in a disc and display means and central processing means for processing information input by a user or recorded information in the inserted disc, wherein the central processing means inputs and sets a reference for the user input means to perform finalizing processing, detects the presence/absence of a finalizing record of the inserted disc and an amount of remaining capacity therein to decide whether the detected amounts meet the reference or not, displays a selection as to whether or not to perform finalizing processing, performs finalizing processing in response to a selected finalizing processing request, and performs processing of unloading the disc.

2. The recording/reproducing device according to claim 1, wherein an amount of remaining capacity of the disc and an amount of remaining capacity therein according to a recording mode are included as the reference for input settings and these amounts are displayed on a finalizing processing selection screen.

3. A recording method for the recording/reproducing device, comprising the steps of inputting/setting a reference for the user input means to perform finalizing processing, detecting the presence/absence of a finalizing record in an inserted disc and an amount of remaining capacity therein to decide whether the detected amounts meet the reference or not, displaying a selection as to whether or not to perform finalizing processing, performing finalizing processing in response to a request for selected finalizing processing, and performing processing of unloading the disc.
